(19) United States
(12) Patent Application Publication
(10) Pub. No.: US 2022/0168767 A1
(43) Pub. Date: Jun. 2, 2022

(54) COLD SPRAY DEVICE

(71) Applicant: Nissan Motor Co., Ltd., Yokohama-shi, Kanagawa (JP)

(72) Inventors: Hirohisa SHIBAYAMA, Kanagawa (JP); Koukichi KAMADA, Kanagawa (JP); Haruhiko SUZUKI, Kanagawa (JP); Eiji SHIOTANI, Kanagawa (JP); Hidenobu MATSUYAMA, Kanagawa (JP)

(21) Appl. No.: 17/598,934

(22) PCT Filed: Mar. 29, 2019
(86) PCT No.: PCT/JP2019/014151

§ 371 Date: Sep. 28, 2021

(51) Int. Cl. B05B 13/02; B05B 13/04; C23C 24/04

(52) U.S. Cl. CPC B05B 13/0278; C23C 24/04; B05B 13/0431

(57) ABSTRACT

A cold spray device basically include at least a pedestal, a base plate, a motor, a spray gun, a high-pressure pipe and a rotating joint. The pedestal is configured to support a workpiece in a predetermined orientation. The base plate is disposed in a position away from the workpiece. The motor is arranged to cause the base plate to rotate about a rotational axis. The spray gun is mounted on the base plate so that a spray direction is directed toward the rotational axis. The high-pressure pipe guides a working gas to the spray gun. The rotating joint is provided to a base end of the high-pressure pipe. The high-pressure pipe is arranged along the rotational axis.

### CROSS-REFERENCE TO RELATED APPLICATIONS

This application is a U.S. national stage application of International Application No. PCT/JP2019/014151, filed on Mar. 29, 2019.

### BACKGROUND

### Technical Field

The present invention relates to a cold spray device that performs a film formation process while a spray gun having a nozzle rotates around a rotational axis.

### Background Information

There is known in the art a laser cladding device that forms a cladding layer by thermal spraying using a laser beam on a valve seat part of a cylinder head of an internal combustion engine (Japanese Patent No. 4038724 B2—Patent Document 1). With this laser cladding device, the cylinder head is secured, and a cladding layer is formed while a lasering head that discharges a powder material while emitting a laser beam is rotated around an axial line of a valve seat. There are also known valve seat films formed by cold spraying, which is different from the thermal spray mentioned above, as valve seat films that have a high film formation speed and that can be thick.

### SUMMARY

However, cold spraying, unlike thermal spraying, requires a high-pressure hose for guiding high-pressure working gas to a spray gun, and the high-pressure hose is considerably stiff; therefore, it is difficult to cause the spray gun to rotate around an axis line, and even if the spray gun is caused to rotate, the responsiveness of delicate movements is extremely poor. When the spray gun is secured and the cylinder head, which is a workpiece, is caused to rotate, this requires a space larger than the range occupied by the rotation of the cylinder head.

A problem to be solved by the present invention is to provide a cold spray device with which rotational operation of the spray gun is easy and responsiveness of movement is high.

The present invention overcomes the problem described above by providing a rotating joint to a base end of a high-pressure pipe that supplies working gas to a spray gun, and arranging the high-pressure pipe along a rotational axis of the spray gun.

According to the present invention, because a high-pressure pipe is arranged along a rotational axis of a spray gun, when the spray gun is caused to rotate around the rotational axis, the high-pressure pipe rotates smoothly on a tip-end side beyond a rotating joint without being twisted. Any stiffness that would occur when the high-pressure pipe is twisted can thereby be prevented, and the spray gun therefore has high responsiveness of rotating movement.

### BRIEF DESCRIPTION OF THE DRAWINGS

Referring now to the attached drawings which form a part of this original disclosure.

FIG. 1 is a cross-sectional view of a cylinder head on which a valve seat film is formed using a cold spray device according to the present invention;

FIG. 2 is an enlarged cross-sectional view of a periphery of the valve of FIG. 2;

FIG. 3 is a configuration diagram of one embodiment of the cold spray device according to the present invention;

FIG. 4 is a front view of a spray gun of one embodiment of the cold spray device according to the present invention;

FIG. 5 is a cross-sectional view alone line along line V-V in FIG. 4;

FIG. 6 is a front view of a state in which the spray gun in FIG. 4 has been offset;

FIG. 7 is a front view of a film formation factory including the cold spray device according to present invention;

FIG. 8 is a plan view of FIG. 7;

FIG. 9 is a flowchart of a procedure for manufacturing a cylinder head using the cold spray device according to the present invention.

FIG. 10 is a perspective view of a cylinder head rough material on which a valve seat film is formed using the cold spray device according to the present invention.

FIG. 11 is a cross-sectional view of an intake port along line XI-XI of FIG. 10.

FIG. 12 is a cross-sectional view of a state in which an annular valve seat part has been formed by a cutting step in the intake port of FIG. 11.

FIG. 13 is a cross-sectional view of a state in which a valve seat film is formed in the intake port of FIG. 12.

FIG. 14 is a cross-sectional view of an intake port in which a valve seat film has been formed.

FIG. 15 is a cross-sectional view of an intake port after the finishing step of FIG. 9.

### DETAILED DESCRIPTION OF EMBODIMENTS

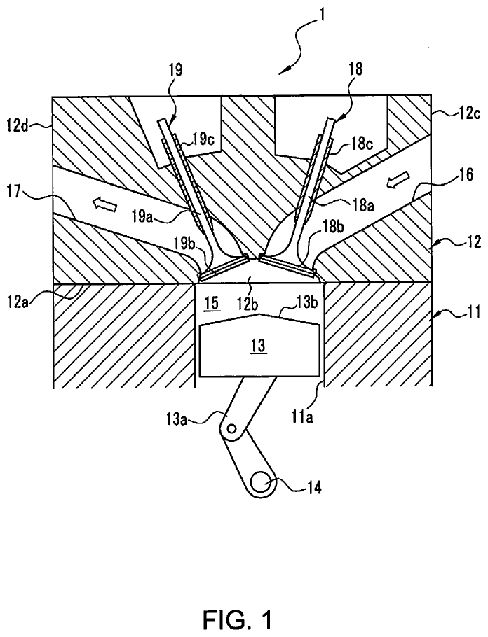

An embodiment of the present invention is described below on the basis of the drawings. There shall first be described an internal combustion engine 1 provided with a valve seat film, in which a cold spray device of the embodiment is preferably applied. FIG. 1 is a cross-sectional view of the internal combustion engine 1, showing mainly the configuration around the cylinder head.

The internal combustion engine 1 comprises a cylinder block 11 and a cylinder head 12 assembled on an upper part of the cylinder block 11. The internal combustion engine 1 is, for example, an in-line four-cylinder gasoline engine, and the cylinder block 11 has four cylinders 11a arranged in the depth direction of the drawing. The cylinders 11a accommodate pistons 13 that move in a reciprocating manner vertically in the drawing, and the pistons 13 link via connecting rods 13a to crankshafts 14 extending in the depth direction of the drawing.

In a surface 12a of the cylinder head 12 that attaches to the cylinder block 11, in positions corresponding to the cylinders 11a, four recesses 12b constituting combustion chambers 15 of the cylinders are formed. The combustion chambers 15 are spaces for combusting an air-fuel mixture of fuel and intake air, and are configured from the recesses 12b of the cylinder head 12, top surfaces 13b of the pistons 13, and inner peripheral surfaces of the cylinders 11a.

The cylinder head 12 is provided with intake ports 16 via which the combustion chambers 15 and one side surface 12c of the cylinder head 12 communicate. The intake ports 16 assume a substantially cylindrical form that is curved, and guide intake air into the combustion chambers 15 from an intake manifold (not shown) connected to the side surface 12c. The cylinder head 12 is also provided with exhaust ports 17 that communicate the combustion chambers 15 and another side surface 12d of the cylinder head 12. The exhaust ports 17 have roughly cylindrical shapes curved in the same manner as the intake ports 16, and discharge exhaust air produced in the combustion chambers 15 to an exhaust manifold (not shown) connected to the side surface 12d. The internal combustion engine 1 of the present embodiment has two intake ports 16 and exhaust ports 17 each for one cylinder 11a.

The cylinder head 12 is provided with intake valves 18 that open and close the intake ports 16 in relation to the combustion chambers 15, and exhaust valves 19 that open and close the exhaust ports 17 in relation to the combustion chambers 15. The intake valves 18 and the exhaust valves 19 are each provided with a valve stem 18a or 19a in the form of a round rod and a valve head 18b or 19b in the form of a disc provided at a distal end of the valve stem 18a, 19a. The valve stems 18a and 19a are slidably inserted through roughly cylindrical valve guides 18c, 19c assembled in the cylinder head 12. The intake valves 18 and the exhaust valves 19 are thereby free to move along axial directions of the valve stems 18a and 19a in relation to the combustion chambers 15.

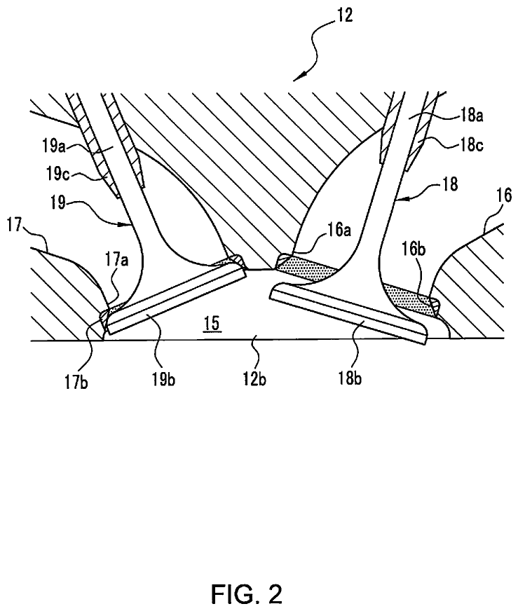

FIG. 2 is an enlarged view of a communicating portion between a combustion chamber 15, an intake port 16, and an exhaust port 17. The intake port 16 has a roughly cylindrical opening 16a provided in the portion communicating with the combustion chamber 15. Formed in an annular edge part of the opening 16a is an annular valve seat film 16b that comes into contact with the valve head 18b of the intake valve 18. When the intake valve 18 moves upward along the axial direction of the valve stem 18a, an upper surface of the valve head 18b comes into contact with the valve seat film 16b and closes up the intake port 16. Conversely, when the intake valve 18 moves downward along the axial direction of the valve stem 18a, a gap is formed between the upper surface of the valve head 18b and the valve seat film 16b and the intake port 16 is opened.

The exhaust port 17 is provided with a roughly circular opening 17a in the communicating portion between the intake port 16 and the combustion chamber 15, and formed in an annular edge part of the opening 17a is an annular valve seat film 17b that comes into contact with the valve head 19b of the exhaust valve 19. When the exhaust valve 19 moves upward along the axial direction of the valve stem 19a, an upper surface of the valve head 19b comes into contact with the valve seat film 17b and closes up the exhaust port 17. Conversely, when the exhaust valve 19 moves downward along the axial direction of the valve stem 19a, a gap is formed between the upper surface of the valve head 19b and the valve seat film 17b and the exhaust port 17 is opened. A diameter of the opening 16a of the intake port 16 is set larger than a diameter of the opening 17a of the exhaust port 17.

In the four-cycle internal combustion engine 1, only the intake valve 18 is opened when the piston 13 descends, whereby the air-fuel mixture is introduced into the cylinder 11a from the intake port 16 (intake stroke). The intake valve 18 and the exhaust valve 19 are then closed, and the piston 13 is raised to roughly top dead center to compress the air-fuel mixture inside the cylinder 11a (compression stroke). When the piston 13 has reaches roughly top dead center, the compressed air-fuel mixture is ignited by a sparkplug and the air-fuel mixture thereby explodes. This explosion causes the piston 13 to descend to bottom dead center, and the explosion is converted to rotational force via a linked crankshaft 14 (combustion/expansion stroke). Lastly, when the piston 13 reaches bottom dead center and begins to ascend again, only the exhaust valve 19 is opened and exhaust inside the cylinder 11a is discharged to the exhaust port 17 (exhaust stroke). The internal combustion engine 1 generates output by repeating the cycle described above.

The valve seat films 16b and 17b are formed by cold spraying directly on the annular edge parts of the openings 16a and 17a of the cylinder head 12. Cold spraying is a method in which a working gas at a temperature lower than the melting point or softening point of a raw material powder is brought to a supersonic flow, the working gas is charged with raw material powder carried by a carrier gas, the gas with the powder is sprayed from a nozzle tip to collide with a base material while in a solid-phase state, and a coating film is formed by plastic deformation of the raw material powder. In comparison to thermal spraying, in which a material is melted and deposited on a base material, the characteristics of cold spraying are that a dense coating film that does not oxidize can be obtained in the atmosphere, thermal alteration is minimized because the effect of heat on the material particles is small, the film is formed at a fast rate, the film can be made thicker, and adhesion efficiency is high. Because of the fast film-forming rate and the thick film in particular, cold spraying is suitable when the present invention is applied with structural materials such as the valve seat films 16b and 17b of the internal combustion engine 1.

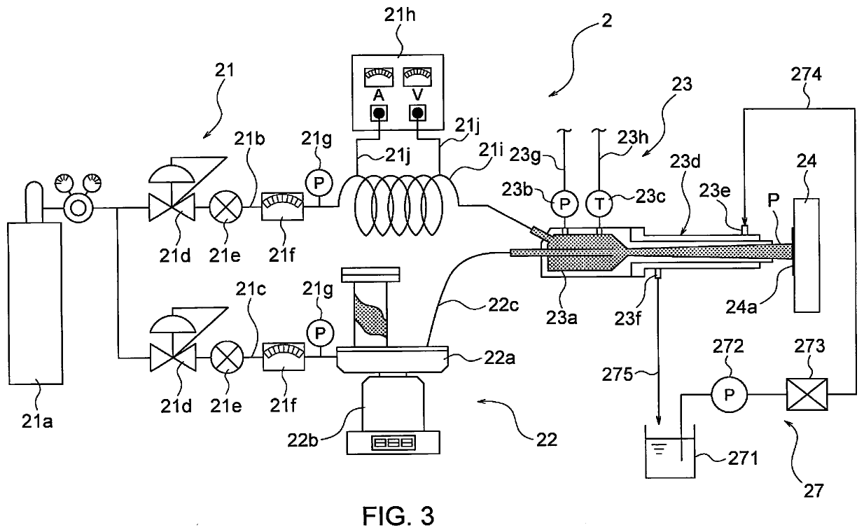

FIG. 3 is a schematic diagram of a cold spray device 2 of the present embodiment, which is used to form the valve seat films 16b and 17b described above. The cold spray device 2 of the present embodiment is provided with a gas supply section 21 that supplies the working gas and the carrier gas, a raw material powder supply section 22 that supplies the raw material powder for the valve seat films 16b and 17b, a spray gun 23 that sprays the raw material powder as a supersonic flow using working gas of which the temperature is not higher than the melting point of the powder, and a refrigerant circulation circuit 27 that cools a nozzle 23d.

The gas supply section 21 is provided with a compressed gas vessel 21a, a working gas line 21b, and a carrier gas line 21c. The working gas line 21b and the carrier gas line 21c are each provided with a pressure adjuster 21d, a flow rate adjustment valve 21e, a flow rate gauge 21f, and a pressure gauge 21g. The pressure adjusters 21d, the flow rate adjustment valves 21e, the flow rate gauges 21f, and the pressure gauges 21g are supplied to adjust the respective pressures and flow rates of the working gas and carrier gas from the compressed gas vessel 21a.

A tape heater or another heater 21i is installed in the working gas line 21b, and the heater 21i heats the working gas line 21b by being supplied with electric power from an electric power source 21h via electric power supply lines 21j, and 21j. The working gas is introduced into a chamber 23a of the spray gun 23 after being heated by the heater 21i to a temperature lower than the melting point or softening point of the raw material powder. A pressure gauge 23b and a thermometer 23c are installed on the chamber 23a, a pressure value and a temperature value detected via respective signal lines 23g and 23g are outputted to a controller (not shown), and these values are supplied for feedback control of the pressure and temperature.

The raw material powder supply section 22 is provided with a raw material powder supply device 22a, and a weighing scale 22b and a raw material powder supply line 22c added to the raw material powder supply device 22a. The carrier gas from the compressed gas vessel 21a passes through the carrier gas line 21c and is introduced into the raw material powder supply device 22a. A predetermined amount of raw material powder weighed by the weighing scale 22b is carried into the chamber 23a via the raw material powder supply line 22c.

The spray gun 23 sprays the raw material powder P, which has been carried into the chamber 23a by the carrier gas, from the tip of the nozzle 23d at a supersonic flow with the aid of the working gas, and causes the raw material powder P to collide in a solid-phase state or in a solid-liquid coexistent state with a base material 24 to form a coating film 24a. In the present embodiment, the cylinder head 12 is applied as the base material 24, and the valve seat films 16b and 17b are formed by spraying the raw material powder P by cold spraying onto the annular edge parts of the openings 16a and 17a of the cylinder head 12.

The nozzle 23d is internally provided with a flow channel (not shown) through which water or another refrigerant flows. The tip end of the nozzle 23d is provided with a refrigerant introduction part 23e through which the refrigerant is introduced into the flow channel, and a base end of the nozzle 23d is provided with a refrigerant discharge part 23f through which the refrigerant in the flow channel is discharged. The refrigerant is introduced into the flow channel of the nozzle 23d through the refrigerant introduction part 23e, the refrigerant flows through the flow channel, and the refrigerant is discharged from the refrigerant discharge part 23f, whereby the nozzle 23d is cooled.

The refrigerant circulation circuit 27, via which the refrigerant is circulated through the flow channel of the nozzle 23d, is provided with a tank 271 that stores the refrigerant, an introduction pipe 274 connected to the above-described refrigerant introduction part 23e, a pump 272 that is connected to the introduction pipe 274 and that causes the refrigerant to flow between the tank 271 and the nozzle 23d, a cooler 273 that cools the refrigerant, and a discharge pipe 275 connected to the refrigerant discharge part 23f. The cooler 273 is composed of, for example, a heat exchanger, etc., and the cooler causes the refrigerant that has cooled the nozzle 23d and risen in temperature to exchange heat with air, water, gas, or another refrigerant, thus cooling the refrigerant.

Refrigerant stored in the tank 271 is drawn into the refrigerant circulation circuit 27 by the pump 272, and the refrigerant is supplied to the refrigerant introduction part 23e via the cooler 273. The refrigerant supplied to the refrigerant introduction part 23e flows through the flow channel in the nozzle 23d from the tip-end side toward the rear-end side, during which time the refrigerant exchanges heat with the nozzle 23d and the nozzle 23d is cooled. Having flowed to the rear-end side of the flow channel, the refrigerant is discharged from the refrigerant discharge part 23f to the discharge pipe 275, and returns to the tank 271. Thus, the refrigerant is circulated in the refrigerant circulation circuit 27 while being cooled, so that the nozzle 23d is cooled, and therefore, the raw material powder P can be kept from adhering to the spray passage of the nozzle 23d.

The valve seats of the cylinder head 12 require heat resistance and abrasion resistance high enough to withstand striking input from the valves in the combustion chambers 15, as well as thermal conductivity high enough to cool the combustion chambers 15. To comply with these requirements, the valve seat films 16b and 17b, which are formed from, for example, a powder of a precipitation-hardening copper alloy, make it possible to obtain valve seats that are harder than the cylinder head 12, which is formed from an aluminum alloy for casting, and that have exceptional heat resistance and abrasion resistance.

Because the valve seat films 16b and 17b are formed directly on the cylinder head 12, it is possible to achieve higher thermal conductivity than in prior-art valve seats in which separate seat rings are pressed-fitted and formed in port openings. Furthermore, compared to cases of using separate seat rings, not only is it possible to bring the valve seat films closer to a water jacket for cooling, but it is also possible to achieve secondary effects such as increasing throat diameters of the intake ports 16 and the exhaust ports 17 and promoting tumble flow by optimizing port shape.

The raw material powder P used to form the valve seat films 16b and 17b is preferably a metal that is harder than aluminum alloys for casting and that yields the heat resistance, abrasion resistance, and thermal conductivity needed for the valve seats; for example, it is preferable to use the precipitation-hardening copper alloy mentioned above. A Corson alloy containing nickel and silicon, chromium copper containing chromium, zirconium copper containing zirconium, etc., can be used as the precipitation-hardening copper alloy. Furthermore, for example: a precipitation-hardening copper alloy containing nickel, silicon, and chromium; a precipitation-hardening copper alloy containing nickel, silicon, and zirconium; a precipitation-hardening alloy containing nickel, silicon, chromium, and zirconium; a precipitation-hardening copper alloy containing chromium and zirconium; etc., can be applied.

Additionally, multiple types of raw material powders, e.g., a first raw material powder and a second raw material powder can be mixed to form the valve seat films 16b and 17b. In this case, for the first raw material powder it is preferable to use a metal that is harder than aluminum alloys for casting and that yields the heat resistance, abrasion resistance, and thermal conductivity needed for the valve seats; for example, it is preferable to use a precipitation-hardening copper alloy mentioned above. Additionally, a metal harder than the first raw material powder is preferably used as the second raw material powder. For example, an iron-based alloy, a cobalt-based alloy, a chromium-based alloy, a nickel-based alloy, a molybdenum-based alloy, or another alloy, or a ceramic, etc., can be applied as the second raw material powder. Additionally, one of these metals can be used alone, or a combination of two or more can be used as appropriate.

Valve seat films formed by mixing a first raw material powder and a second raw material powder harder than the first raw material powder can have better heat resistance and abrasion resistance than valve seat films formed from only a precipitation-hardening copper alloy. Such effects are achieved presumably because the second raw material powder causes an oxide coating film present on the surface of the cylinder head 12 to be removed and a new interface to be formed by exposure, and adhesiveness between the cylinder head 12 and the metal coating film improves. Such effects are also presumably because adhesiveness between the cylinder head 12 and the metal coating film are improved by an anchor effect brought about by the second raw material powder being embedded in the cylinder head 12. Furthermore, such effects are presumably because when the first raw material powder collides with the second raw material powder, some of the kinetic energy thus produced is converted to heat energy or some of the first raw material powder plastically deforms, and the heat produced by this process further promotes precipitation hardening in some of the precipitation-hardening copper alloy used as the first raw material powder.

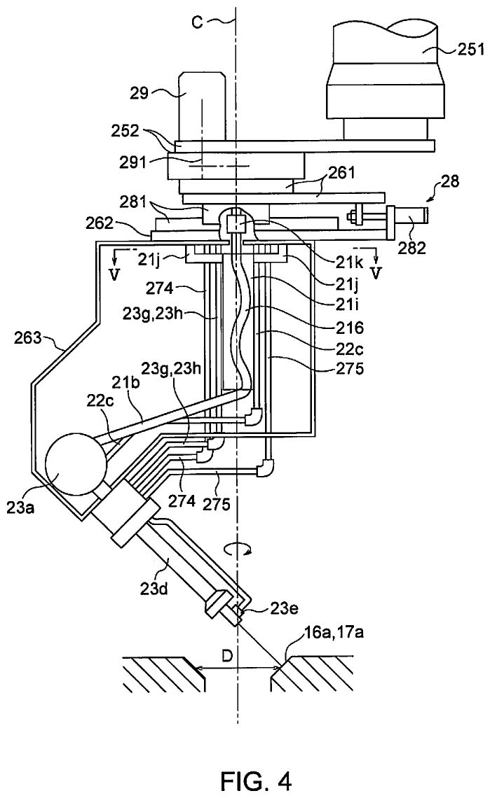

In the cold spray device 2 of the present embodiment, the cylinder head 12 in which the valve seat films 16b and 17b are formed is secured to a pedestal 45, and the tip end of the nozzle 23d of the spray gun 23 is rotated along the annular edge parts of the openings 16a and 17a of the cylinder head 12, whereby raw material powder is sprayed. The cylinder head 12 is not caused to rotate and therefore does not need to occupy a large space, and the spray gun 23 has a smaller moment of inertia than the cylinder head 12 and therefore has exceptional rotational transient characteristics and responsiveness. However, because a high-pressure pipe (high-pressure hose) constituting the working gas line 21b is connected to the spray gun 23 as shown in FIG. 3, there is a possibility that the rotational transient characteristics and responsiveness will be impeded by deformation rigidity due to twisting of the hose of the working gas line 21b when the spray gun 23 is caused to rotate. In view of this, the rotational transient characteristics and responsiveness are improved by configuring the cold spray device 2 of the present embodiment as shown in FIGS. 4 to 8.

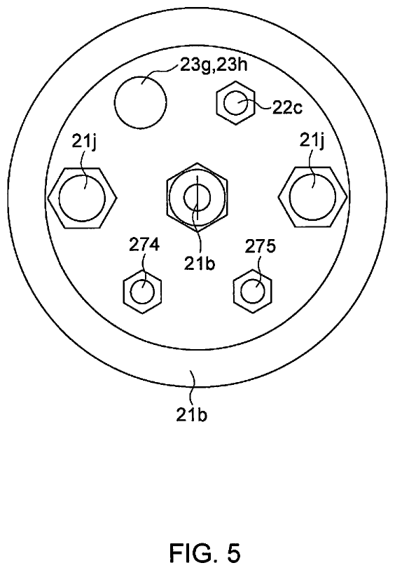

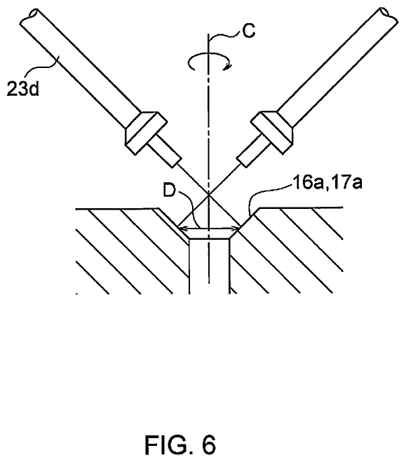

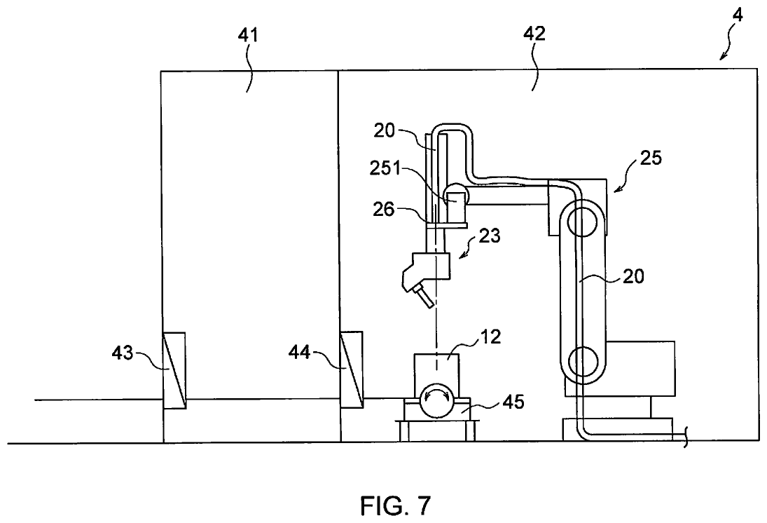

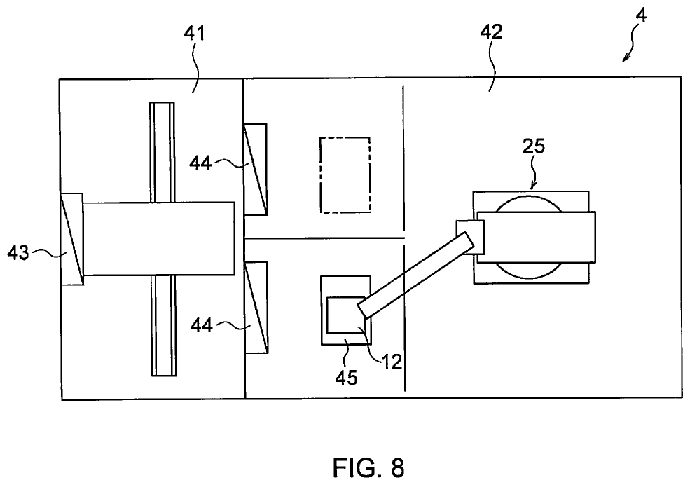

FIG. 4 is a front view of the spray gun 23 of one embodiment of the cold spray device 2 according to the present invention, FIG. 5 is a cross-sectional view along line V-V in FIG. 4, FIG. 6 is a front view of a state in which the spray gun 23 in FIG. 4 is offset, FIG. 7 is a front view of a film formation factory including the cold spray device 2 according to the present invention, and FIG. 8 is a plan view of FIG. 7.

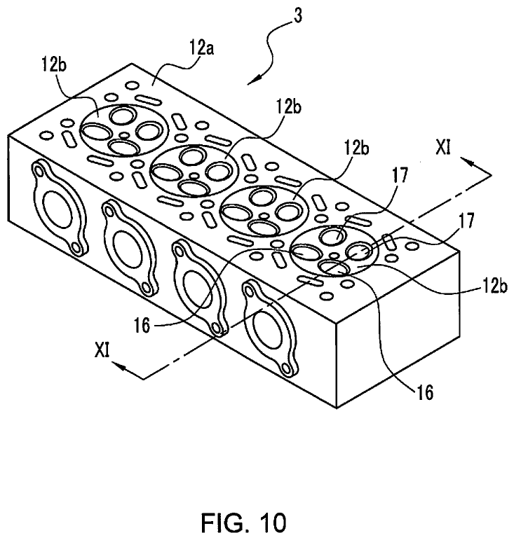

The cylinder head 12, which is a workpiece, is placed in a predetermined orientation on the pedestal 45 of a film formation booth 42 of a film formation factory 4 shown in FIGS. 7 and 8. For example, as shown in FIG. 10, the cylinder head 12 is secured to the pedestal 45 so that the recesses 12b of the cylinder head 12 are at the upper surface, and the pedestal 45 is tilted so that center lines of the openings 16a of the intake ports 16 or center lines of the openings 17a of the exhaust ports 17 are oriented in a vertical direction.

The film formation factory 4 is provided with the film formation booth 42, in which a film formation process is carried out, and a carrier booth 41. A pedestal 45 on which the cylinder head 12 is placed and an industrial robot 25 that holds the spray gun 23 are installed in the film formation booth 42. The carrier booth 41 is provided at the front portion of the film formation booth 42, cylinder heads 12 are carried in and out between the exterior and the carrier booth 41 through a door 43, and cylinder heads 12 are carried in and out between the carrier booth 41 and the film formation booth 42 through a door 44. For example, when the film formation process for one cylinder head 12 is being performed in the film formation booth 42, a cylinder head 12 that has ended the preceding process is carried out to the exterior from the carrier booth 41. Because the film formation process performed by the cold spray device 2 involves noise produced by supersonic shock waves, scattering of raw material powder, etc., the carrier booth 41 is installed and the film formation process is performed with the door 44 closed, whereby other operations can be performed simultaneously with the film formation process, such as carrying out a processed cylinder head 12 and carrying in a to-be-processed cylinder head 12.

The spray gun 23 is rotatably mounted on a base plate 26 secured to a hand 251 of the industrial robot 25 installed in the film formation booth 42 of the film formation factory 4 shown in FIGS. 7 and 8. A configuration of the spray gun 23 of the present embodiment is described below with reference to FIGS. 4 to 6. First, as shown in FIG. 4, a bracket 252 is secured to the hand 251 of the industrial robot 25, the base plate 26 is rotatably attached to the bracket 252, and the spray gun 23 is secured to the base plate 26.

More specifically, as shown in FIGS. 4 and 5, the bracket 252 is secured to the hand 251 of the industrial robot 25, a body of a motor 29 is secured to the bracket 252, a drive shaft 291 of the motor 29 is connected to a first base plate 261 via a pulley and a belt (not shown), and the first base plate 261 is caused to rotate relative to the bracket. The motor 29 rotates in two directions over a range of, for example, 360° at maximum. The base plate 26 is composed of the first base plate 261 and a second base plate 262, and the first base plate 261 and the second base plate 262 are provided so as to be capable of sliding in a direction (the left-right direction in FIG. 4) orthogonal to a rotational axis C via a linear guide 281. An amount by which the second base plate 262 is offset relative to the first base plate 261 is adjusted and a spray diameter D of a film-forming material is set by driving a hydraulic cylinder 282.

A cover 263 is mounted on the second base plate 262 and the spray gun 23 is secured to a lower end part of the cover. The spray gun 23 is secured to the second base plate 262 via the cover 263 so that the spraying direction of the nozzle 23d is directed toward the rotational axis C. Because the second base plate 262 can be offset in relation to the first base plate 261 by the linear guide 281 and the hydraulic cylinder 282 mentioned above, the position of the tip end of the nozzle 23d of the spray gun 23 can be adjusted to be horizontal in relation to the rotational axis C.

Thus, when the position of the tip end of the nozzle 23d is set from being on the line of the rotational axis C shown in FIG. 4 to a position away from the rotational axis C as shown in FIG. 6, the spray diameter D will be smaller should the gun distance be the same. Because the openings 16a of the intake ports 16 are larger in diameter than the openings 17a of the exhaust ports 17, the tip end is in the position on the rotational axis C shown in FIG. 4 when the valve seat films 16b are formed in the openings 16a of the intake ports 16, and the tip end is in the position separated from the rotational axis C shown in FIG. 6 when the valve seat films 17b are formed in the openings 17a of the exhaust ports 17.

The working gas line 21b shown in FIG. 3, which guides high-pressure gas at 3-10 MPa supplied from the compressed gas vessel 21a to the spray gun 23, forms one pipe bundle 20 with other pipes described hereinafter, and hangs down to reach the spray gun 23 from an upper part of the base plate 26 mounted to the hand 251 of the industrial robot 25 as shown in FIG. 7. Near the base plate 26 in this configuration, the working gas line is separably connected via a swivel joint or another rotating joint 21k, and the heater 21i is provided below the coupling, as shown in FIG. 4. The working gas line 21b shown in FIG. 4, extending from the rotating joint 21k to the chamber 23a, is configured from a high-pressure hose that can withstand high pressures of 3-10 MPa, and is arranged along the rotational axis C so as to encircle the axis, as shown in FIG. 4. The working gas line 21b can be shaped into, for example, a helix in advance so as to encircle the rotational axis C, but a high-pressure hose that can withstand high pressures of 3-10 MPa is hard and retains shape; therefore, a shape-retaining mold can be provided on the outer periphery so that the high-pressure hose conforms to the helical shape.

The raw material powder supply line 22c, which is shown in FIG. 3 and which guides the raw material powder supplied from the raw material powder supply device 22a to the spray gun 23, is arranged in the periphery of the industrial robot 25 as the pipe bundle 20 shown in FIG. 7, is hung down to the spray gun 23 from the upper part of the base plate 26. Below the base plate 26 in this configuration, the raw material powder supply line 22c is configured in the pipe arrangement including metal pipes and metal couplings and is connected to the chamber 23a of the spray gun 23 as shown in FIG. 4.

The electric power supply lines 21j, and 21j, which are shown in FIG. 3 and which guide electric power supplied from the electric power source 21h to the heater 21i, are arranged in the periphery of the industrial robot 25 as the pipe bundle 20 shown in FIG. 7, hung down from the upper part of the base plate 26, and connected to the heater 21i. Additionally, a signal line 23g that outputs a detection signal from the pressure gauge 23b to a controller (not shown) and a signal line 23h that outputs a detection signal from the thermometer 23c to a controller (not shown), these signal lines being shown in FIG. 3, are inserted through piping including metal pipes and metal couplings from the chamber 23a of the spray gun 23, and in this state the signal lines are guided from the chamber 23a of the spray gun 23 to the second base plate 262, and along with other components such as the working gas line 21b, the raw material powder supply line 22c, and the electric power supply lines 21j, are arranged in the periphery of the industrial robot 25 from the upper part of the base plate 26.

The introduction pipe 274 and the discharge pipe 275, which are shown in FIG. 3 and which guide the refrigerant supplied from the refrigerant circulation circuit 27 to the nozzle 23d of the spray gun 23, are arranged in the periphery of the industrial robot 25 as the pipe bundle 20 shown in FIG. 7, hung from the upper part of the base plate 26, and connected to the refrigerant introduction part 23e at the tip end of the nozzle 23d and the refrigerant discharge part 23f at the base end of the nozzle 23d. Below the base plate 26 in this configuration, the introduction pipe 274 and the discharge pipe 275 are configured in the piping including the metal pipes and metal couplings and are connected to the nozzle 23d of the spray gun 23, as shown in FIG. 4.

As described above, the working gas line 21b, which is configured from a high-pressure hose that is hard and very stiff against deformation, is arranged such that the rotating joint 21k thereof is disposed on the line of the rotational axis C as shown in FIG. 4, and below the rotating joint 21k, the working gas line extends along and encircles the rotational axis C. Other than the working gas line 21b, the electric power supply lines 21j, and 21j, the raw material powder supply line 22c, the introduction pipe 274, the discharge pipe 275, and the signal lines 23g, 23h are disposed around the rotational axis C in positions encircling the working gas line 21b, as shown in FIG. 5.

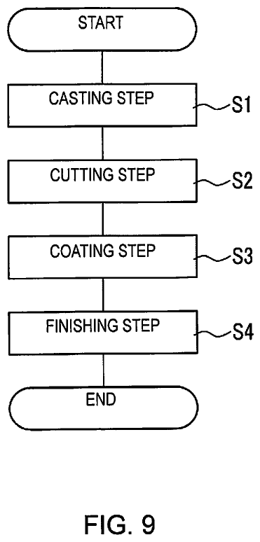

Next, the method for manufacturing the cylinder head 12 provided with the valve seat films 16b and 17b shall be described. FIG. 9 is a flowchart of steps for processing the valve portion in the method for manufacturing the cylinder head 12 of the present embodiment. The method for manufacturing the cylinder head 12 of the present embodiment includes a casting step S1, a cutting step S2, a coating step S3, and a finishing step S4, as shown in FIG. 9. The steps for processing portions other than the valve are omitted for the sake of simplifying the description.

In the casting step S1, an aluminum alloy for casting is poured into a mold in which a sand core has been set, and cylinder head rough material, having intake ports 16, exhaust ports 17, etc., formed in a body section, is shaped by casting. The intake ports 16 and the exhaust ports 17 are formed in the sand core, and recesses 12b are formed in the die. FIG. 10 is a perspective view of a cylinder head rough material 3 shaped by casting in the casting step S1, as seen from a side of an attachment surface 12a for the cylinder block 11. The cylinder head rough material 3 is provided with four recesses 12b, and the recesses 12b each have two intake ports 16 and two exhaust ports 17. The two intake ports 16 and the two exhaust ports 17 of an individual recess 12b merge together in the cylinder head rough material 3, and all communicate with openings provided in both side surfaces of the cylinder head rough material 3.

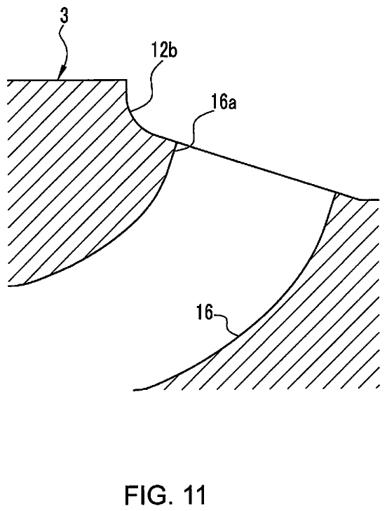

FIG. 11 is a cross-sectional view of the cylinder head rough material 3 along line XI-XI of FIG. 10, showing an intake port 16. The intake port 16 is provided with a circular opening 16a exposed in a recess 12b of the cylinder head rough material 3.

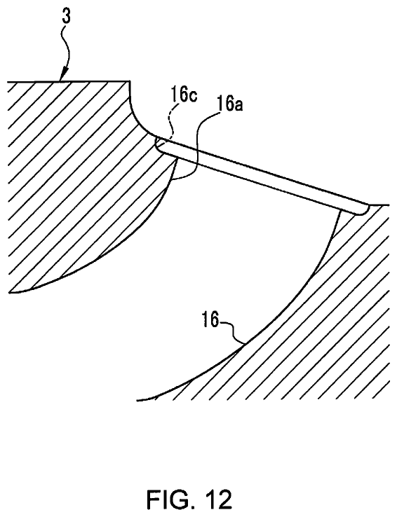

In the next cutting step S2, the cylinder head rough material 3 is subjected to milling by an end mill, a ball end mill, etc., and an annular valve seat part 16c is formed in the opening 16a of the intake port 16 as shown in FIG. 12. The annular valve seat part 16c is an annular groove constituting a base shape of a valve seat film 16b, and is formed in an outer periphery of the opening 16a. In the method for manufacturing the cylinder head 12 of the present embodiment, the raw material powder P is sprayed by cold spraying to form a coating film on the annular valve seat part 16c, and the valve seat film 16b is formed on the coating film as a foundation. Therefore, the annular valve seat part 16c is formed to be one size larger than the valve seat film 16b.

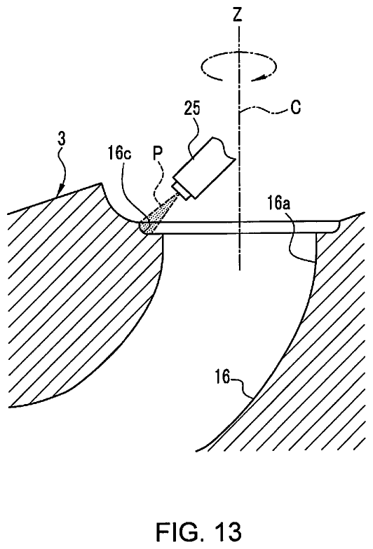

In the coating step S3, the raw material powder P is sprayed onto the annular valve seat part 16c of the cylinder head rough material 3 using the cold spray device 2 of the present embodiment, and the valve seat film 16b is formed. More specifically, in the coating step S3, the cylinder head rough material 3 is secured in place and the spray gun 23 is rotated at a constant speed so that the raw material powder P is blown onto the entire periphery of the annular valve seat part 16c while the annular valve seat part 16c and the nozzle 23d of the spray gun 23 are kept at a constant distance in the same orientation, as shown in FIG. 13.

The tip end of the nozzle 23d of the spray gun 23 is held in the hand 251 of the industrial robot 25, above the cylinder head 12 secured to the pedestal 45. The pedestal 45 or the industrial robot 25 sets the position of the cylinder head 12 or the spray gun 23 so that a center axis Z of the intake port 16 in which the valve seat film 16b is formed is vertical and is the same as the rotational axis C, as shown in FIG. 4. In this state, a coating film is formed on the entire periphery of the annular valve seat part 16c due to the spray gun 23 being rotated about the C axis by the motor 29 while the raw material powder P is blown onto the annular valve seat part 16c from the nozzle 23d.

While the coating step S3 is being carried out, the nozzle 23d introduces the refrigerant supplied from the refrigerant circulation circuit 27 into the flow channel from the refrigerant introduction part 23e. The refrigerant cools the nozzle 23d while flowing from the tip-end side toward the rear-end side of the flow channel formed inside the nozzle 23d. Having flowed to the rear-end side of the flow channel, the refrigerant is discharged from the flow channel by the refrigerant discharge part 23f and recovered.

When the spray gun 23 rotates once about the C axis and the formation of the valve seat film 16b ends, the rotation of the spray gun 23 is temporarily stopped. During this rotation stoppage, the industrial robot 25 moves the spray gun 23 so that the center axis Z of the intake port 16 in which the valve seat film 16b will next be formed coincides with a reference axis of the industrial robot 25. After the spray gun 23 has finished being moved by the industrial robot 25, the motor 29 restarts the rotation of the spray gun 23 and a valve seat film 16b is formed on the next intake port 16. The valve seat films 16b and 17b are hereinafter formed on all of the intake ports 16 and exhaust ports 17 of the cylinder head rough material 3 by repeating this operation. When the spray gun 23 switches between forming a valve seat film on the intake ports 16 and forming a valve seat film on the exhaust ports 17, the tilt of the cylinder head rough material 3 is changed by the pedestal 45.

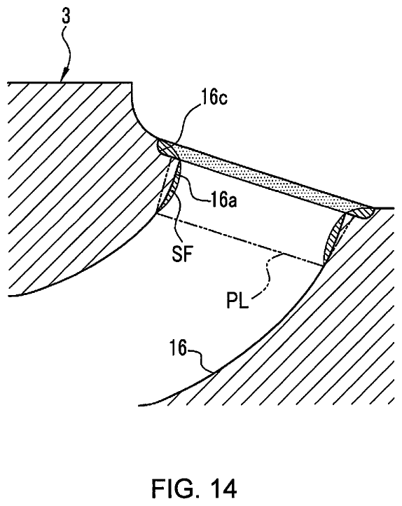

In the finishing step S4, finishing is performed on the valve seat films 16b and 17b, the intake ports 16, and the exhaust ports 17. In the finishing of the valve seat films 16b and 17b, the surfaces of the valve seat films 16b and 17b are milled using a ball end mill, and the valve seat films 16b are adjusted to a predetermined shape. In the finishing of the intake ports 16, a ball end mill is inserted into the intake ports 16 from the openings 16a, and the inner peripheral surfaces of the intake ports 16 at the sides having the openings 16a are each cut along a processing line PL shown in FIG. 14. The processing line PL is a range in which a surplus coating film SF, which results from the raw material powder P scattering and adhering to the inside of the intake port 16, is formed comparatively thick; i.e., a range in which the surplus coating film SF is formed thick enough to affect the intake performance of the intake port 16.

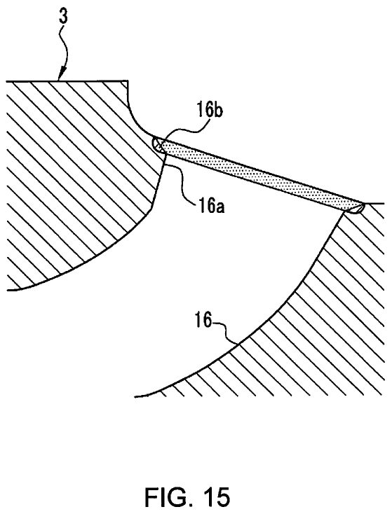

Thus, through the finishing step S4, surface roughness in the intake ports 16 due to cast-shaping is eliminated, and the surplus coating film SF formed in the coating step S3 can be removed. FIG. 15 shows an intake port 16 after the finishing step S4. As with the intake port 16, a valve seat film 17b is formed in the exhaust port 17 via formation of a small-diameter part in the exhaust port 17 by cast-shaping, formation of an annular valve seat part by cutting, cold spraying on the annular valve seat part, and finishing. Therefore, a detailed description shall not be given for the procedure of forming the valve seat films 17b in the exhaust ports 17.

As described above, with the cold spray device 2 of the present embodiment, when the spray gun 23 is caused to rotate about a rotational axis, the working gas line 21b (high-pressure pipe) having the rotating joint 21k provided at the base end is formed along the rotational axis C in the form of, for example, a helix that encircles the rotational axis C; therefore, the tip-end side of the working gas line 21b beyond the rotating joint 21k smoothly rotates about the rotational axis C without being twisted when the spray gun 23 is caused to rotated around the rotational axis. The stiffness that arises when the working gas line 21b is twisted at this time is adequately low, and the transient characteristics and responsiveness of the rotational movements of the spray gun 23 therefore improve.

With the cold spray device 2 of the present embodiment, the moment of inertia when the spray gun 23 is caused to rotate about the rotational axis C becomes smaller because the raw material powder supply line 22c, which guides the film-forming material to the spray gun 23, the introduction pipe 274 and the discharge pipe 275, which guide the refrigerant to the nozzle 23d of the spray gun 23 and circulate the refrigerant, the electric power supply lines 21j, and 21j, which supply electric power to the heater 21i which heats the working gas line 21b, and the signal lines 23g, 23h of the pressure gauge 23b and the thermometer 23c mounted on the spray gun 23 are disposed around the rotational axis C. As a result, the transient characteristics and responsiveness of the rotational movements of the spray gun 23 further improve.

With the cold spray device 2 of the present embodiment, because the base plate 26 includes the first base plate 261 to which the motor 29 is secured, the second base plate 262 on which the spray gun 23 is mounted, and an offset mechanism 28 that causes the first base plate 261 and the second base plate 262 to move relative to each other in a first direction orthogonal to the rotational axis C, even if the diameters of the valve seat films 16b and 17b to be formed are different, it is possible to make an adaptation.

With the cold spray device 2 of the present embodiment, it is possible to further minimize twisting in the working gas line 21b even when the spray gun 23 is caused to rotate because the rotating joint 21k is disposed on the line of the rotational axis C.

With the cold spray device 2 of the present embodiment, it is possible to provide a highly productive and versatile cold spray device because the cold spray device 2 is further provided with the industrial robot 25 having the hand 251 on which the base plate 26 is mounted, and the industrial robot 25 is taught to sequentially move the spray gun 23 to a plurality of coating-film-forming locations on the cylinder head 12.

The working gas line 21b is equivalent to a high-pressure pipe according to the present invention, the raw material powder supply line 22c is equivalent to a first pipe according to the present invention, the introduction pipe 274 and the discharge pipe 275 are equivalent to second pipes according to the present invention, and the motor 29 is equivalent to a rotation means according to the present invention.

1. A cold spray device at least comprising:
a pedestal configured to support a workpiece in a predetermined orientation,
a base plate disposed in a position away from the workpiece;
a motor arranged to cause means that causes the base plate to rotate about a rotational axis;
a spray gun mounted on the base plate so that a spray direction is directed toward the rotational axis;
a high-pressure pipe connected to the spray gun at a tip end to guide a working gas to the spray gun; and
a rotating joint provided to a base end of the high-pressure pipe,
the high-pressure pipe being arranged along the rotational axis.

2. The cold spray device according to claim 1, further comprising
a first pipe configured to guide a film-forming material to the spray gun;
a second pipe configured to guide and circulate cooling water to a nozzle of the spray gun;
an electric power supply line configured to supply electric power to a heater that heats the high-pressure pipe; and
a signal line for a sensor mounted on the spray gun,
the first pipe, the second pipe, the electric power supply line, and the signal line being disposed around the rotational axis.

3. The cold spray device according to claim 1, wherein
the base plate includes
a first base plate to which the motor is secured,
a second base plate on which the spray gun is mounted, and
an offset mechanism configured to cause the first base plate and the second base plate to move relative to each other in a first direction orthogonal to the rotational axis.

4. The cold spray device according to claim 1, wherein
the rotating joint is disposed on the line of the rotational axis.

5. The cold spray device according to claim 1, further comprising
an industrial robot having a hand to which the base plate is mounted,
the industrial robot being taught an operation to sequentially move the spray gun to a plurality of film-deposited portions on the workpiece.
